(19) United States
(12) Patent Application Publication
(10) Pub. No.: US 2004/0230663 A1
(43) Pub. Date: Nov. 18, 2004

(54) Sharing photos electronically

(75) Inventor: Jerry Ackerman, Burnsville, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: icu Software, Inc., Burnsville, MN

(21) Appl. No.: 10/836,388

(22) Filed: Apr. 30, 2004

Related U.S. Application Data
(60) Provisional application No. 60/467,775, filed on May 2, 2003.

(51) Int. Cl. G06F 15/16

(52) U.S. Cl. 709/207

(57) ABSTRACT

A method for a computer user to share photos electronically begins when the user identifies one or more photos that are stored on a computer as files. Files for each identified photo are uploaded from the computer to a webspace that is controlled by the user. HTML code is generated for an email message to be used for sharing the photos from the user to a recipient of the email message. The HTML code includes a source path instruction for each identified photo as it is stored on the webspace. Due to the source path instruction, the identified photos are not attached to the email message itself. This enables the email message to be of a small, manageable size. The email recipient may read the email message and may access the identified photos using standard email and browser software.

### CROSS-REFERENCE TO RELATED APPLICATION

This application claims the benefit of U.S. Provisional Application No. 60/467,775 filed May 2, 2003, the contents of which are incorporated by reference.

### BACKGROUND OF THE INVENTION

E-mail is a great means of communicating for business, family and friends. As digital cameras are undergoing phenomenal sales growth, sharing digital images through e-mail has become part of our culture. The downside is picture preparation—it is time consuming and tedious. To make matters worse, e-mail applications are closing the door on attachments due to virus concerns.

Today's digital cameras provide crystal clear images at the expense of large file sizes. If you have attempted to share one of these images, you most likely found this task nearly impossible. These large images tend to overload e-mail server space as well as your Internet connection due to limited bandwidth.

The two methods currently used for sharing photos from a PC are as attachments to an email message or by using one of many online photo sharing services. Both of these suffer from several deficiencies, some of which are listed below:

Attachments

(1) Email servers were designed to provide text messaging between large numbers of people and not to transfer large attachments. The demands on an email system include indexing, reply, storage and other options that may be available to the subscriber, many times surpassing the demands placed on hosted webservers. A text message file may only be 5 kb and pass through the process of management and delivery efficiently, being forwarded to the recipient's email server via a manageable number of IP packets where upon request by the recipient is quickly downloaded to his desktop or other device. However an attachment requires large amounts of space by comparison. Thus, a huge number of IP packets are required and the operation must be completed before a time-out, while in addition the file size must not exceed the file size restrictions, this is many times confused with email storage space of which is also unknown by the sender and can be exceeded very easily, other failures are deprived from the fact that Email servers overload and fail when email queues hit peaks.

(2) Attachments, especially those from new mega-pixel cameras, can be large in file size and cause Internet connection failures or deliberate disconnects from ISP's

(3) Attachment file names are the only way to define meaning or association within the message

(4) A high speed Internet connection does not provide resolution to email failure. It only returns the failure faster, Internet connection speed is independent of the recipients email server.

(5) Attachments require an additional software application to enable preview. This taxes the PC, requiring more memory as well as additional screen space.

(6) When attachments are opened on a recipient's machine, they lose their association to the message.

(7) When forwarding or responding to a message with an attachment the attachment must be uploaded and downloaded through the email server subjecting the sender and recipient to the problematic issues defined above.

(8) Attachments require time consuming preparation.

(9) Attachments in email are being eliminated, email services are restricting size and applications like Microsoft Outlook have already banned 30 file attachment types.

(10) Attachments carry viruses and can cause damage to a users machine or email server when opened.

(11) Recipients are reluctant to open attachments

Online Photo Sharing Services

(1) Online photo sharing services limit the size and clarity of photo preview and in many cases place text on the photo to prevent a viewer from downloading and printing, Photo Sharing services are in the business to sell printed photos, allowing large photos for preview would eliminate profit.

(2) While those that advertise the ability to share in email, they only provide a link in the email to their website.

(3) The people you want to share photos with must join most photo sharing services, providing email addresses or additional personal information

(4) In order to preview photos on a online photo sharing site viewers are subjected to advertising and popups

(5) While uploading, if you lose the connection, you must manually reconnect and discern between the photos sent and not sent

(6) You do not have the ability to collaborate with photos and text between parties

(7) You must point your browser to an online address and use a user name and password to enable preview

### SUMMARY OF THE INVENTION

In one aspect of the present invention, a method for a computer user to share photos electronically begins when the user identifies one or more photos that are stored on a computer as files. Files for each identified photo are uploaded from the computer to a webspace that is controlled by the user. HTML code is generated for an email message to be used for sharing the photos from the user to a recipient of the email message. The HTML code includes a source path instruction for each identified photo as it is stored on the webspace. Due to the source path instruction, the identified photos are not attached to the email message itself. This enables the size of the email message to be small since the message does not include any jpg files, but rather only HTML tags and the text of the message. The email recipient may read the email message and may access the identified photos using standard email and browser software.

### BRIEF DESCRIPTION OF THE DRAWINGS

FIG. 1 is a flowchart illustrating the general steps of the invention.

### DETAILED DESCRIPTION OF THE INVENTION

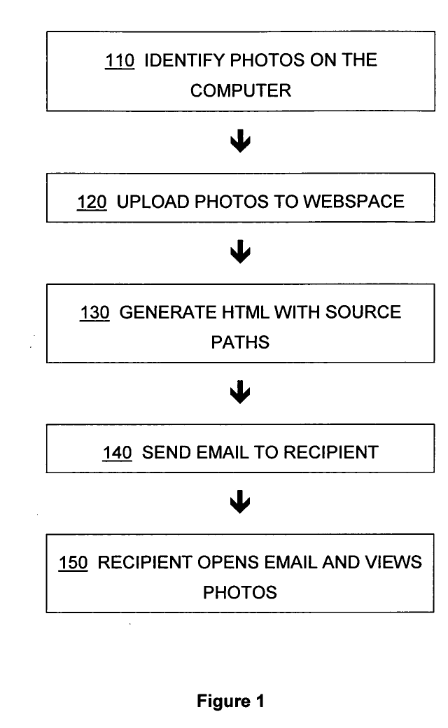

FIG. 1 shows the general steps of one embodiment of the present invention. In this embodiment, the process begins with step 110, where a computer user may identify one or more photos that the user wants to share via email. These identified photos are uploaded to the user's webspace at step 120 and HTML is generated at step 130 for an new email message. This HTML includes source path information for each photo stored on the webspace. At steps 140, the email message is sent to one or more recipients. The recipient may use his/her usual email software to read the email (step 150). By clicking on links in the email message, the user may use his/her usual browser software to view the photos.

These five general steps of the present invention will now be discussed in more detail.

Identify Photos (Step 110)

In one embodiment of the invention, photos are identified (step 110) for insertion into the application through Windows XP's auto load process which uses the operating system to identify an application (such as a software product sold by Applicant, referred here as an “icu software product”) or through menu options that provide a form for photo selections, in either case selected photos are rewritten to provide stamps that appear in a photo viewer, while the original content is saved for content mining at a later point in time.

After the photos are loaded into the viewer they may be all or individually targeted for email using a single click on select photos or by using the menu action “select all”.

After selections are made from the viewer, selecting the menu option “Email” opens the film strip form that displays the photo selections for reconsideration's.

Upload Photos (Step 120)

The upload process (step 120) will now be elaborated on by discussing a series of steps taken by one embodiment of the invention, and by referring to portions of relevant source code from U.S. Provisional Application No. 60/467,775.

Step 1: Selected photos for email are sized and compressed according to preset or default settings. (See module mod1_Preparelmages in the provisional application)

Step 2: If the user has decided to include a copyright, the photos are written when sized and compressed to include such. (See frm_SYS_Properties/C:Copyrite)

Step 3: The connection type and status is checked using Inet, this is a windows operating service. (See frm_SYS_Properties/H:Connection State Info)

Step 4: A website is pinged to ensure an Internet connection is established, if one is not the user is prompted to connect. (See frm_Ping_Hidden)

Step 5: A page (Store_Tableset.htm) is downloaded from icu software that provides marketing material and an insertion point named “@icufilm” for the html code that is to be generated. (See HTML01_BuildTableset)

Step 6: A URL name is automatically defined or the user can define one for usage later in the process

Step 7: The URL is written to the Store_Tableset whereas in the case of an email recipient does not have html enabled mail, the URL will be exposed to provide the recipient with a path to the online version. (See Function HTML_LinkText( ))

Step 8: If the User has selected to expose the online version address to recipients, the URL is written to be exposed. (See Function HTML_AddHyperlink)

Step 9: The user's preference to use password protection for photos and html stored on the web is checked, if true and enabled, Html is created for file paths in the email message that include the password and username in the URL paths, (See Function HTML_AddHyperlink)

Step 10: If password protection is true but not enabled, the user is prompted to include in this session the prepared scripts that enable file locking with a unique username and password, if yes scripts are prepared and included in the temp folder for uploading automatically. (See frmSYS_Properties)

Step 11: If the user has photo locking on, the password and username are included in the future visible email message.

Step 12: Html is created for photo content that will display in the email message—where as a path to the URL not a link is written. (See Public Sub MailLinkPassword)

Step 13: Html is written for links to additional pages that will display max, hotspot photos and the online version. (See mod2_PrepareHTM)

Step 14: The above Html is combined and inserted onto the Store_Tableset page at a predefined insertion point. (See mod2_PrepareHTM)

Step 15: Html is created for the display of photo content that is to be viewed through links outside of the email message, this includes hotspots, maximized previews and an email instance copy for website preview.

Step 16: All files to be uploaded to the unique URL are placed into a local temp folder

Step 17: A connection is made to the user's web space (See mod3_FTPFilesToServer)

Step 18: If space is available, the temp folder files are uploaded via ftp to the new URL and deleted from the local temp folder one at a time.

Step 19: A process form provides the user a view of the process. (See frmFTP_Proccessing)

Step 20: If the connection is broken, a reconnection process prompts the user to reconnect and send using the automated reconnection process, if the user does not respond, the application reconnects automatically and continues to finish the upload automatically (See frmFTP_Reconnect)

Step 21: The reconnection process ensures the Internet connection as well as the webspace connection providing successful uploads from portable devices that may be connected using a cell phone transmission tower or satellite, for example transmitting from a traveling plane, car boat or motorcycle.

Step 22: When the upload process is completed, depending upon the user's preference, a new email message appears in the icu software application, Microsoft Outlook or is available for pasting into any other html email application like Microsoft Express (See Forms frm_Email & frm_EmailExpress.)

Generate HTML (Step 130)

The HTML generation process will now be elaborated on by discussing a series of steps taken by one embodiment of the invention, and by referring to portions of relevant source code from U.S. Provisional Application No. 60/467,775.

Step 1: Selected photos for email are sized and compressed according to preset or default settings. (See Module mod1_Preparelmages.)

Step 2: If the user has decided to include a copyright, the photos are written at the time they are sized and compressed to include such. (See Module modR_Routines.)

Step 3: The connection type and status is checked using Inet, this is a windows operating service.

Step 4: A website is pinged to ensure an Internet connection is established, if one is not the user is prompted to connect. (See Module modC_CNN.)

Step 5: In the case where the user has selected to email The a web page called called “Store_Tableset” is returned to the users machine from the icu web server. In the case a user selects to preview, preview/print or save the entire instance to a file, a html page “Local_Tableset” is picked up from the users local files instead of the icu Web Server.

Step 6: The page “Store_Tableset” provides marketing dependant upon the icu web servers database merchant value. A merchant Id is added to the online database in the case an alliance is made by icu software with an ISP or retailer, in that case the alliances marketing material is written into the Store_Tableset providing an impression for the sender and all recipients. An impression may include merchant information, links and other marketing info. The StoreTableset.htm html can be edited programmatically or manually online to include background effects, marketing and to provide the application with operating information.

Step 7: The Store_Tableset page is scanned for details that can change the way the application processes or looks for the next Store_Tableset.htm URL (See Function UPDATE_REGISTRY.)

Step 8: A URL name is automatically defined or the user can define one for usage later in the process (See Form frmlMG_Targeted.)

Step 9: The URL is written to the Store_Tableset whereas in the case of an email recipient does not have html enabled mail, the URL will be exposed to provide the recipient with a path to the online version. (See Module Mod2_PrepareHTML.)

Step 10: If the User has selected to expose the online version address to recipients, the URL is written to be exposed. (See Function HTML_AddHyperlink.)

Step 11: The users preference to use password protection for photos and html stored on the web is checked, if true and enabled, Html is created for file paths in the email message that include the password and username in the URL paths, (See Public Sub MailLinkPassword)

Step 12: If password protection is true but not enabled, the user is prompted to include in this session the prepared scripts that enable file locking with a unique username and password, if yes scripts are prepared and included in the temp folder for uploading automatically.

Step 13: If the user has photo locking on, the password and username are included in the future visible email message.

Step 14: Html is created for photo content that will display in the email message—where as a path to the URL not a link is written. (See mod2_PrepareHTML.)

Step 15: Html is written for links to additional pages that will display max, hotspot photos and the online version.

Step 16: The above Html is combined and inserted onto the Store_Tableset page at a predefined insertion point.

Step 17: Html is created for the display of photo content that is to be viewed through links outside of the email message, this includes hotspots, maximized previews and an email instance copy for website preview.

Step 18: All files to be uploaded to the unique URL are placed into a local temp folder

Step 19: A connection is made to the users web space (See Module mod3_FTPFilesTo Server.)

Step 20: If space is available, the temp folder files are uploaded via ftp to the new URL and deleted from the local temp folder one at a time.

Step 21: A process form provides the user a view of the process.

Step 22: If the connection is broken, a reconnection process prompts the user to reconnect and send using the automated reconnection process, if the user does not respond, the application reconnects automatically and continues to finish the upload automatically (See Form frmFTP_Reconnect.)

Step 23: The reconnection process ensures the Internet connection as well as the webspace connection providing successful uploads from portable devices that may be connected using a cell phone transmission tower or satellite, for example transmitting from a traveling plane, car boat or motorcycle.

Step 24: In the case of menu option, email, when the upload process is completed, depending upon the users preference, a new email message appears in the icu software application, Microsoft Outlook or is available for pasting into any other html email application like Microsoft Express. In the case of menu options—Preview, Print or Save—the new Store_Tableset page html points to local files for it's supporting files and opens in a Preview form or is saved to a location the user defines. (See Forms frmEmail & frmEmailExpress)

Send Email and Read (Steps 140 and 150)

In one embodiment of the invention, after the photos selections are sized and compressed and html is created and uploaded to a web space, an email message version is provided to the user within the built in email application, Microsoft Outlook or available on the clipboard for pasting into any html capable email application.

The email message is html and displays the photos in the message body, the photos display due to the fact their coded paths point to the web unique web space where the supporting files have been uploaded, this provides an email message that is the size of the amount of text and html tags, regardless of the number of photos to be shared with the email message. This means that the email message is quite manageable by Outlook and other standard email viewing programs as the message is generally like most other email messages—it is made up of the user's text message along with some HTML to format the message and to show the linked photos. The small email file size is what provides the abilities to pass through email servers. The fact that the photos live on the server allows the user to share large photo file sizes created from the mega-pixel cameras used today.

The email message also provides other selective options the user has included, such as Maximize buttons or hotspots on images, these links upon selection, open the senders or recipients default browser and open the path to the html located on the web that provides the photo that is also located on the web space.

If the file protection is enabled at the time of email creation, the email message provides an image of a lock and the instances username and password that are required to open the link. The Internet Browser provides the user the forms for password entry and the user simply needs to look at the email message for the username and password that is included through automation. The photos that appear in the email message look at the locked folder that requires password and username, however the password and username is included in the photo path, providing the folder to be unlocked automatically so the photos can display without user interaction.

If hotspots are created on photos prior to sending from within the Image Editor (See Form frmlMG_Editor and Module mode_Editor.), the photos selective content will also appear in the users browser. The selective content was deprived from the original photo at the time of the email instances creation and provides a maximized view of the subject material. (See Module mod2_PrepareHTML.)

A sender can also send to a list of recipients using an address book within the icu mail application or other application of choice, the process allows any selection of recipients at one time without additional uploads. (See Form frmAddrBk.)

A recipient upon receiving an email using this process is not subjected to extended waiting time, images are downloaded into the message from the webserver instead of a slow email server.

A recipient may add comments to each photo and respond instantly without any upload because the message file size remains the weight of the text.

The foregoing description addresses embodiments encompassing the principles of the present invention. The embodiments may be changed, modified and/or implemented using various types of arrangements. Those skilled in the art will readily recognize various modifications and changes that may be made to the invention without strictly following the exemplary embodiments and applications illustrated and described herein, and without departing from the scope of the invention, which is set forth in the following claims.

What is claimed is:

1. A method for a computer user to share photos electronically, comprising:
identifying at least one photo from a plurality of photos stored as files on a computer;
uploading from the computer at least one file for each identified photo to a webspace controlled by the user; and
generating HTML code for an email message;
wherein the HTML code includes a source path for each identified photo stored on the webspace;
wherein the at least one photo is not attached to the email message for enabling the email message to be of manageable size; and
wherein a recipient of the email message may view each identified photo using a email reader program and a web browser program.

2. The method from claim 1, wherein the at least one file comprises a photo file and an HTML file for presenting the photo to a viewer.

3. The method from claim 1, wherein the HTML code of the email message comprises an advertising message.

4. The method from claim 1, wherein the HTML code of the email message comprises a maximize feature for displaying the photo in a maximum mode.

5. The method from claim 1, further comprising the step of sizing the identified photo.

6. The method from claim 1, further comprising the step of determining a size for a maximum mode.

7. The method from claim 1, further comprising the step of compressing each identified photo.

8. The method from claim 1, further comprising the step of password protecting the identified photo.

9. The method from claim 1, further comprising the step of associating a copyright notice to the identified photo.

10. The method from claim 1, further comprising creating a hotspot region upon the identified photo.

11. A system for sharing photos electronically, comprising:
means for identifying at least one photo from a plurality of photos stored as files on a computer;
means for uploading from the computer at least one file for each identified photo to a webspace controlled by the user; and
means for generating HTML code for an email message;
wherein the HTML code includes a source path for each identified photo stored on the webspace;
wherein the at least one photo is not attached to the email message for enabling the email message to be of manageable size; and
wherein a recipient of the email message may view each identified photo using a email reader program and a web browser program.

12. The system from claim 11, wherein the at least one file comprises a photo file and an HTML file for presenting the photo to a viewer.

13. The system from claim 11, wherein the HTML code of the email message comprises an advertising message.

14. The system from claim 11, wherein the HTML code of the email message comprises a maximize feature for displaying the photo in a maximum mode.

15. The system from claim 11, further comprising means for sizing the identified photo.

16. The system from claim 11, further comprising means for determining a size for a maximum mode.

17. The system from claim 11, further comprising means for compressing each identified photo.

18. The system from claim 11, further comprising means for password protecting the identified photo.

19. The system from claim 11, further comprising means for associating a copyright notice to the identified photo.

20. The system from claim 11, further comprising means for creating a hotspot region upon the identified photo.

21. A computer program stored on a computer readable medium for execution by a computer for sharing photos electronically, the computer program comprising:
a code segment for identifying at least one photo from a plurality of photos stored as files on a computer;
a code segment for uploading from the computer at least one file for each identified photo to a webspace controlled by the user; and
a code segment for generating HTML code for an email message;
wherein the HTML code includes a source path for each identified photo stored on the webspace;
wherein the at least one photo is not attached to the email message for enabling the email message to be of manageable size; and
wherein a recipient of the email message may view each identified photo using a email reader program and a web browser program.

22. The computer program from claim 21, wherein the at least one file comprises a photo file and an HTML file for presenting the photo to a viewer.

23. The computer program from claim 21, wherein the HTML code of the email message comprises an advertising message.

24. The computer program from claim 21, wherein the HTML code of the email message comprises a maximize feature for displaying the photo in a maximum mode.

25. The computer program from claim 21, further comprising a code segment for sizing the identified photo.

26. The computer program from claim 21, further comprising a code segment for determining a size for a maximum mode.

27. The computer program from claim 21, further comprising a code segment for compressing each identified photo.

28. The computer program from claim 21, further comprising a code segment for password protecting the identified photo.

29. The computer program from claim 21, further comprising a code segment for associating a copyright notice to the identified photo.

30. The computer program from claim 21, further comprising a code segment for creating a hotspot region upon the identified photo.
